(19) United States
(12) Patent Application Publication
(10) Pub. No.: US 2026/0149374 A1
(43) Pub. Date: May 28, 2026

(54) POWER STAGE CONTROL CIRCUIT APPLIED TO VOLTAGE CONVERTER

(71) Applicant: Elite Semiconductor Microelectronics Technology Inc., Hsinchu (TW)

(72) Inventor: Yao-Wei Yang, Hsinchu (TW)

(73) Assignee: Elite Semiconductor Microelectronics Technology Inc., Hsinchu (TW)

(21) Appl. No.: 18/959,634

(22) Filed: Nov. 26, 2024

(51) Int. Cl. H02M 3/158; H02M 1/00

(52) U.S. Cl. CPC H02M 3/158; H02M 1/0009

(57) ABSTRACT

A power stage control circuit applied to a voltage converter includes a current sensing circuit, a control circuit, and a driving circuit, wherein the voltage converter includes a first switch and a second switch. The current sensing circuit senses a current associated with the first switch, and converts current into a sensing voltage. The control circuit performs multiple first logical operations according to the sensing voltage, a second switch driving signal, a zero crossing detection voltage, a compensation voltage, and a reference voltage, in order to generate a modulation signal and a determination signal, for controlling turn-on and turn-off of the first switch and the second switch and dynamically setting an inductor peak current of an inductor, respectively. The driving circuit performs multiple second logical operations according to the modulation signal and the determination signal in order to generate a first switch driving signal and the second switch driving signal.

### BACKGROUND OF THE INVENTION

### 1. Field of the Invention

The present invention is related to a voltage converter, and more particularly, to a power stage control circuit applied to the voltage converter.

### 2. Description of the Prior Art

In the field of a buck converter, when the buck converter operates in a pulse skip mode (PSM), light load efficiency can be improved. Specifically, when the buck converter with the PSM technology operates at a light load condition, the switching frequency of a high-side switch and a low-side switch in a power stage of the buck converter will be reduced, in order to reduce the power consumption of switching. Therefore, the desired light load efficiency can be achieved by the PSM technology. When an inductor current of the buck converter operates in a discontinuous conduction mode (DCM), however, a peak current value of an inductor coupled between the high-side switch and the low-side switch may be limited by some parameters (e.g., an input voltage, an output voltage, the minimum turn-on time of the high-side switch, and an inductance value of the inductor), which may result in reduced design flexibility of the buck converter. As a result, a novel power stage control circuit applied to a voltage converter, which can set the peak current value of the inductor by performing multiple logical control operations, is urgently needed.

### SUMMARY OF THE INVENTION

It is therefore one of the objectives of the present invention to provide a power stage control circuit applied to a voltage converter, in order to address the above-mentioned issues.

According to an embodiment of the present invention, a power stage control circuit applied to a voltage converter is provided, wherein the voltage converter comprises a power stage, the power stage comprises a first switch and a second switch, the first switch and the second switch are connected in series between an input voltage and a first reference voltage, and the input voltage is higher than the first reference voltage. The power stage control circuit comprises a current sensing circuit, a control circuit, and a driving circuit. The current sensing circuit is arranged to sense a current associated with the first switch, and convert the current into a sensing voltage. The control circuit is arranged to perform multiple first logical operations according to the sensing voltage, a second switch driving signal, a zero crossing detection voltage, compensation voltage, and a second reference voltage, in order to generate a modulation signal and a determination signal, for controlling turn-on and turn-off of the first switch and the second switch and dynamically setting an inductor peak current of an inductor, respectively, wherein the inductor has a first terminal coupled between the first switch and the second switch, and a second terminal coupled to an output pin providing an output voltage. The driving circuit is arranged to perform multiple second logical operations according to the modulation signal and the determination signal in order to generate a first switch driving signal and the second switch driving signal, for driving the first switch and the second switch, respectively.

One of the benefits of the present invention is that, by the power stage control circuit (more particularly, the control circuit therein) of the present invention applied to a buck converter, when an inductor current of the buck converter operates in the DCM, an inductor peak current of an inductor coupled between a high-side switch and a low-side switch of a power stage is set to be greater than or equal to a reference current via logic control, which can make the inductor peak current not be limited (or dominated) by some parameters (e.g., an input voltage, an output voltage, the minimum turn-on time of a high-side switch, and an inductance value of the inductor), and therefore can improve the design flexibility of the buck converter. In addition, when the inductor current of the buck converter operates in the DCM and the inductor peak current is substantially equal to the reference current, a next charging cycle of a power stage included in the buck converter is performed only when an inductor current of the inductor is discharged to zero by controlling switching of the high-side switch and the low-side switch via a modulation signal and a determination signal, which can avoid occurrence of larger ripple of the output voltage. That is, when the buck converter operates at a light load condition, the output voltage ripple can be effectively suppressed by the control circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a power stage control circuit applied to a power converter according to an embodiment of the present invention.

FIG. 2 is a diagram illustrating a control circuit according to an embodiment of the present invention.

FIG. 3 is a diagram illustrating a driving circuit according to an embodiment of the present invention.

FIG. 4 is a diagram illustrating a timer circuit according to an embodiment of the present invention.

### DETAILED DESCRIPTION

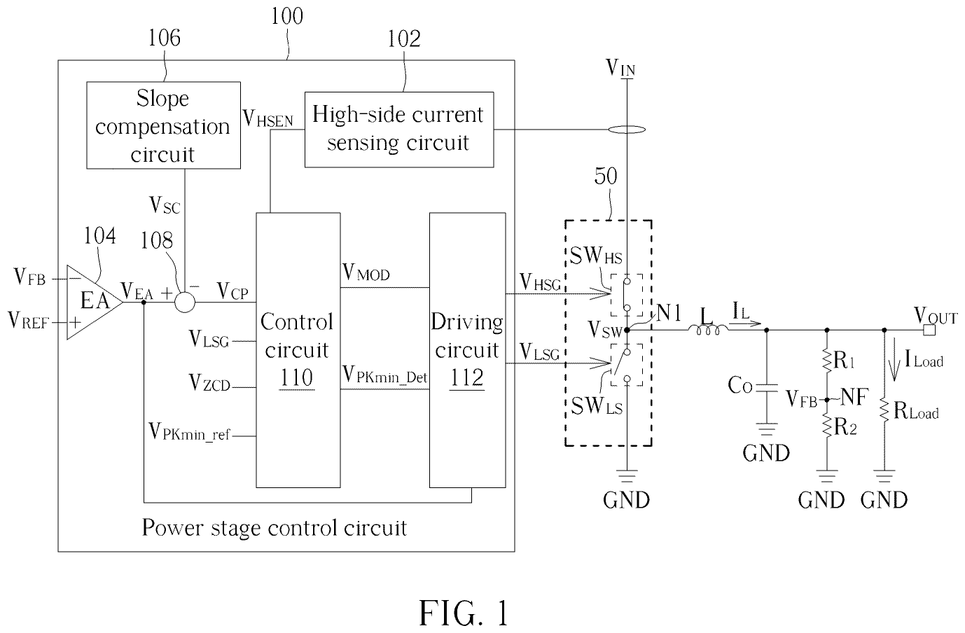

FIG. 1 is a block diagram of a power stage control circuit 100 applied to a voltage converter (e.g., a buck converter) according to an embodiment of the present invention. As shown in FIG. 1, the buck converter may include a power stage 50, and the power stage 50 may be composed of a high-side switch SW_{HS} and a low-side switch SW_{LS}. The high-side switch SW_{HS} has a first terminal coupled to an input voltage V_{IN} and a second terminal. The low-side switch SW_{LS} has a first terminal coupled to the second terminal of the high-side switch SW_{HS} and a second terminal coupled to a grounding voltage GND. That is, the high-side switch SW_{HS} and the low-side switch SW_{LS} are connected in series between the input voltage V_{IN} and the grounding voltage GND. An inductor L has a first terminal coupled to a node N1 that is located between the high-side switch SW_{HS} and the low-side switch SW_{LS}, and a second terminal coupled to an output pin providing an output voltage V_{OUT}, wherein a voltage V_{SW} is provided at the node N1. An output capacitor Co is coupled between the second terminal of the inductor L and the grounding voltage GND. A load device may be modeled by a load resistor R_{Load} coupled between the output pin and the grounding voltage GND, and a load current I_{Load} flows through the load resistor R_{LOAD}. A resistor R₁ has a first terminal coupled to the second terminal of the inductor L and a second terminal. A resistor R₂ has a first terminal coupled to the second terminal of the resistor R₁, and a second terminal coupled to the grounding voltage GND, wherein the resistors R₁ and R₂ act as a voltage divider, a feedback node NF is located between the resistors R₁ and R₂, and a feedback voltage V_{FB} is provided at the feedback node NF for feedback control.

The power stage control circuit 100 may be arranged to receive the feedback voltage V_{FB} from the feedback node NF, and control switching of the high-side switch SW_{HS} and the low-side switch SW_{LS} according to the feedback voltage V_{FB}. Specifically, the power stage control circuit 100 may include a high-side current sensing circuit 102, an error amplifier (EA) 104, a slope compensation circuit 106, a subtraction circuit 108, a control circuit 110, and a driving circuit 112. The high-side current sensing circuit 102 may be coupled to the first terminal of the high-side switch SW_{HS}, and may be arranged to perform a current sensing operation in order to generate a high-side sensing current associated with the high-side switch SW_{HS}, and convert the high-side sensing current into a high-side sensing voltage V_{HSEN}, wherein when the high-side switch SW_{HS} is turned on and the low-side switch SW_{LS} is turned off, the high-side sensing current is an inductor current I_{L} flowing through the inductor L, and a conductance G_{C-HS} of the high-side current sensing circuit 102 may be a product of the inductor current I_{L} and a reciprocal of the high-side sensing voltage V_{HSEN} (i.e., G_{C-HS}=I_{L}/V_{HSEN}).

The error amplifier 104 has a negative input terminal (labeled as “−” in FIG. 1), a positive input terminal (labeled as “+” in FIG. 1), and an output terminal, wherein the negative input terminal receives the feedback voltage V_{FB} from the feedback node NF, the positive input terminal receives a reference voltage V_{REF}, and an error amplifier voltage V_{EA} is generated at the output terminal. The slope compensation circuit 106 is arranged to generate a slope compensation voltage V_{SC}. The subtraction circuit 108 is arranged to subtract the slope compensation voltage V_{SC} from the error amplifier voltage V_{EA} in order to generate a compensation voltage V_{CP} (i.e., V_{CP}=V_{EA}−V_{SC}).

The control circuit 110 may be arranged to perform multiple first logical operations according to the compensation voltage V_{CP} from the subtraction circuit 108, the high-side sensing voltage V_{HSEN} from the high-side current sensing circuit 102, a low-side switch driving signal V_{LSG} from the driving circuit 112, a zero crossing detection voltage V_{ZCD} from the driving circuit 112, and a reference voltage V_{PKmin_ref}, in order to generate a modulation signal V_{MOD} and a determination signal V_{PKmin_Det} for controlling switching (e.g., turn-on and turn-off) of the high-side switch SW_{HS} and the low-side switch SW_{LS} and dynamically setting an inductor peak current I_{PK} of the inductor L, respectively, wherein when the zero crossing detection voltage V_{ZCD} has a high voltage level, it can be determined that the inductor current I_{L} of the buck converter operates in a discontinuous conduction mode (DCM); the low-side switch driving signal V_{LSG} is arranged to drive the low-side switch SW_{LS}; and the determination signal V_{PKmin_Det} may be arranged to determine a current value of the inductor peak current I_{PK}.

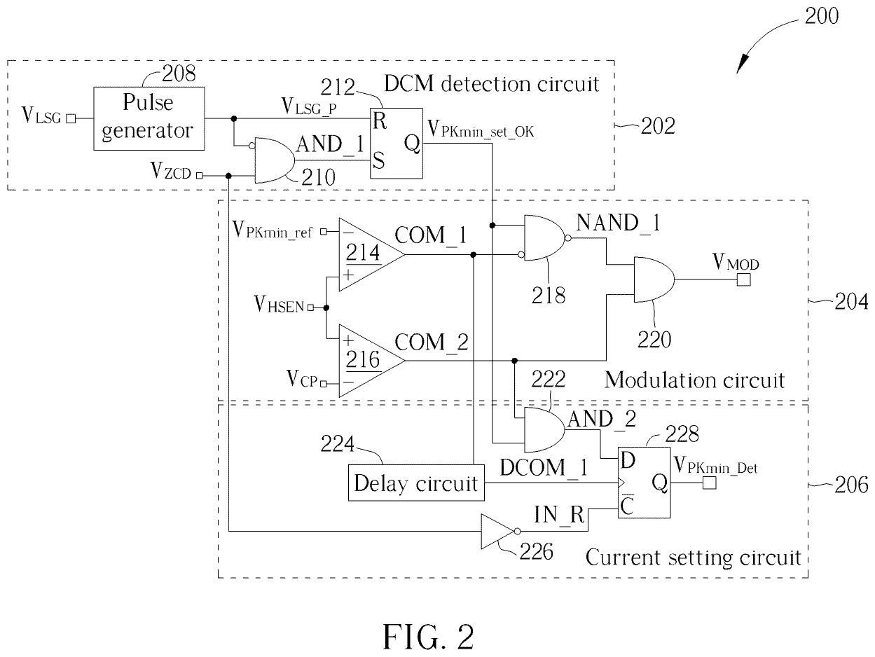

In this embodiment, the inductor peak current I_{PK} can be dynamically set according to a reference current I_{PK_min}, the determination signal V_{PKmin_Det}, and the compensation voltage V_{CP}, wherein the reference current I_{PK_min} is a product of the conductance G_{C-HS} of the high-side current sensing circuit 102 and the reference voltage V_{PKmin_ref} (i.e., I_{PK_min}=G_{C-HS}*V_{PKmin_ref}). Specifically, refer to FIG. 2. FIG. 2 is a diagram illustrating a control circuit 200 according to an embodiment of the present invention, wherein the control circuit 110 shown in FIG. 1 may be implemented by the control circuit 200. As shown in FIG. 2, the control circuit 200 may include a DCM detection circuit 202, a modulation circuit 204, and a current setting circuit 206.

The DCM detection circuit 202 may be arranged to detect whether the inductor current I_{L} of the buck converter operates in the DCM, and may include a pulse generator 208, an AND gate circuit 210, and a set-reset (SR) latch circuit 212. The pulse generator 208 may be arranged to receive the low-side switch driving signal V_{LSG} from the driving circuit 112, and generate a pulse signal V_{LSG_P} according to the low-side switch driving signal V_{LSG}. The AND gate circuit 210 may be arranged to receive an inverse signal of the pulse signal V_{LSG_P} and the zero crossing voltage V_{ZCD}, and perform an AND operation upon the inverse signal and the zero crossing voltage V_{ZCD} in order to generate an AND gate output AND_1. The SR latch circuit 212 has a reset input terminal (labeled as “R” in FIG. 2), a set input terminal (labeled as “S” in FIG. 2), and an output terminal (labeled as “Q” in FIG. 2), wherein the reset input terminal receives the pulse signal V_{LSG_P}, the set input terminal receives the AND gate output AND_1, and a DCM detection signal V_{PKmin_set_OK} is generated at the output terminal for determining whether the inductor current I_{L} of the buck converter operates in the DCM. For example, when the DCM detection signal V_{PKmin_set_OK} has a high voltage level (i.e., the zero crossing detection voltage V_{ZCD} has a high voltage level at the same time), it can be determined that the inductor current I_{L} of the buck converter operates in the DCM.

The modulation circuit 204 may include multiple comparator circuits 214 and 216, a NAND gate circuit 218, and an AND gate circuit 220. The comparator circuit 214 has a negative input terminal (labeled as “−” in FIG. 2) coupled to the reference voltage V_{PKmin_ref} and a positive input terminal (labeled as “+” in FIG. 2) coupled to the high-side sensing voltage V_{HSEN}, and may be arranged to perform a comparison operation upon the reference voltage V_{PKmin_ref} and the high-side sensing voltage V_{HSEN} in order to generate a comparison result COM_1. The comparator circuit 216 has a negative input terminal (“−” in FIG. 2) coupled to the compensation voltage V_{CP} and a positive input terminal (labeled as “+” in FIG. 2) coupled to the high-side sensing voltage V_{HSEN}, and may be arranged to perform a comparison operation upon the compensation voltage V_{CP} and the high-side sensing voltage V_{HSEN} in order to generate a comparison result COM_2. The NAND gate circuit 218 may be arranged to perform a NAND operation upon the DCM detection signal V_{PKmin_set_OK} and an inverse signal of the comparison result COM_1, in order to generate a NAND gate output NAND_1. The AND gate circuit 220 may be arranged to perform an AND operation upon the NAND gate output NAND_1 and the comparison result COM_2, in order to generate the modulation signal V_{MOD} for controlling turn-on and turn-off of the high-side switch SW_{HS} and the low-side switch SW_{LS}.

The current setting circuit 206 may include an AND gate circuit 222, a delay circuit 224, an inverter circuit 226, and a D-type flip flop (DFF) circuit 228. The AND gate circuit 222 may be arranged to perform an AND operation upon the DCM detection signal V_{PKmin_set_OK} and the comparison result COM_2, in order to generate an AND gate output AND_2. The delay circuit 224 may be arranged to perform a delay operation upon the comparison result COM_1, in order to generate a delayed result DCOM_1. The inverter circuit 226 may be arranged to invert the zero crossing detection voltage V_{ZCD} in order to generate an inverted result IN_R. The DFF circuit 228 has an input terminal (labeled as “D” in FIG. 2), a clock terminal, a clear terminal (labeled as “C̅” in FIG. 2), and an output terminal (labeled as “Q” in FIG. 2), wherein the input terminal receives the AND gate output AND_2, the clock terminal receives the delayed result DCOM_1, the clear terminal receives the inverted result IN_R, and the determination signal V_{PKmin_Det} is generated at the output terminal for dynamically setting the inductor peak current I_{PK} of the inductor L.

In detail, the control circuit 200 may dynamically set the inductor peak current I_{PK} of the inductor L via the feedback control and the above-mentioned first logical operations. When the high-side switch SW_{HS} is turned on, in response to a voltage level of the determination signal V_{PKmin_Det} being switched from a low level to a high level, the inductor peak current I_{PK} may be set to be substantially equal to the reference current I_{PK} min (i.e., I_{PK}=I_{PK_min}). When the voltage level of the determination signal V_{PKmin_Det} is the low level, and the compensation voltage V_{CP} is less than the reference voltage V_{PKmin_ref} at end of a turn-on time of the high-side switch SW_{HS}, the inductor peak current I_{PK} may be set to be less than the reference current I_{PK} min (i.e., I_{PK}<I_{PK_min}). When the voltage level of the determination signal V_{PKmin_Det} is the low level, and the compensation voltage V_{CP} is equal to the reference voltage V_{PKmin_ref} at end of the turn-on time of the high-side switch SW_{HS}, the inductor peak current I_{PK} may be set to be substantially equal to the reference current I_{PK} min (i.e., I_{PK}=I_{PK_min}). When the voltage level of the determination signal V_{PKmin_Det} is the low level, and the compensation voltage V_{CP} is greater than the reference voltage V_{PKmin_ref} at end of the turn-on time of the high-side switch SW_{HS}, the inductor peak current I_{PK} may be set to be greater than the reference current I_{PK} min (i.e., I_{PK}>I_{PK_min}). In this way, when the inductor current I_{L} of the buck converter operates in the DCM, the inductor peak current I_{PK} is set to be greater than or equal to the reference current I_{PK} min (i.e., I_{PK}≥I_{PK_min}) by the control circuit 200, which can make the inductor peak current I_{PK} not be limited (or dominated) by some parameters (e.g., the input voltage V_{IN}, the output voltage V_{OUT}, the minimum turn-on time of the high-side switch SW_{HS}, and the inductance value of the inductor L), and therefore can improve the design flexibility of the buck converter.

In addition, when the inductor current I_{L} of the buck converter operates in the DCM and the inductor peak current I_{PK} is substantially equal to the reference current I_{PK_min}, a next charging cycle of the power stage 50 is performed only when the inductor current I_{L} of the inductor L is discharged to zero by controlling switching of the high-side switch SW_{HS} and the low-side switch SW_{LS} via the modulation signal V_{MOD} and the determination signal V_{PKmin_Det}, which can avoid occurrence of larger ripple of the output voltage V_{OUT}. That is, when the buck converter operates at a light load condition, the output voltage ripple can be effectively suppressed by the control circuit 200.

Refer back to FIG. 1. The driving circuit 112 may receive the error amplifier voltage V_{EA} from the error amplifier 104, receive the modulation signal V_{MOD} and the determination signal V_{PKmin_Det} from the control circuit 110, and perform multiple second logical operations according to the error amplifier voltage V_{EA}, the modulation signal V_{MOD}, and the determination signal V_{PKmin_Det}, in order to generate a high-side switch driving signal V_{HSG} and the above-mentioned low-side switch driving signal V_{LSG}, for driving the high-side switch SW_{HS} and the low-side switch SW_{LS}, respectively.

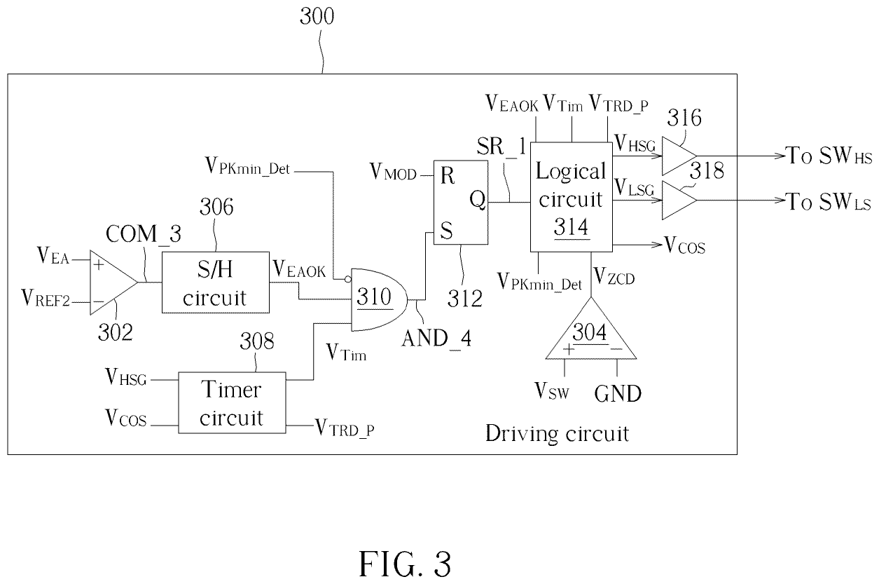

FIG. 3 is a diagram illustrating a driving circuit 300 according to an embodiment of the present invention, wherein the driving circuit 112 shown in FIG. 1 may be implemented by the driving circuit 300. As shown in FIG. 3, the driving circuit 300 may include multiple comparator circuits 302 and 304, a sample and hold circuit 306 (for brevity, labeled as “S/H circuit” in FIG. 3), a timer circuit 308, an AND circuit 310, an SR latch circuit 312, a logical circuit 314, and multiple buffer circuits 316 and 318. The comparator circuit 302 has a negative input terminal (labeled as “−” in FIG. 3) receiving a reference voltage V_{REF2}, a positive input terminal (labeled as “+” in FIG. 3) receiving the error amplifier voltage V_{EA}, and an output terminal outputting a comparison result COM_3. The comparator circuit 304 has a negative input terminal (labeled as “−” in FIG. 3) receiving the grounding voltage GND, a positive input terminal (labeled as “+” in FIG. 3) receiving the voltage V_{SW}, and an output terminal outputting the zero crossing detection voltage V_{ZCD}. The sample and hold circuit 306 may be arranged to perform a sample and hold operation upon the comparison result COM_3 in order to generate an output level detection voltage V_{EAOK} of the error amplifier 104.

The timer circuit 308 may be arranged to receive the high-side switch driving signal V_{HSG} and a control signal V_{COS} from the logical circuit 314, and switch between an oscillator (OSC) mode and a timer mode according to control signal V_{COS}. For example, when the control signal V_{COS} has a high voltage level, the timer circuit 308 may switch to the OSC mode. When the control signal V_{COS} has a low voltage level, the timer circuit 308 may switch to the timer mode. In the OSC mode, the timer circuit 308 may provide an oscillation frequency F_{S}. In the timer mode, the timer circuit 308 may only perform a timing operation with discharging an internal capacitor via a switch controlled by a pulse signal V_{HSG_P}.

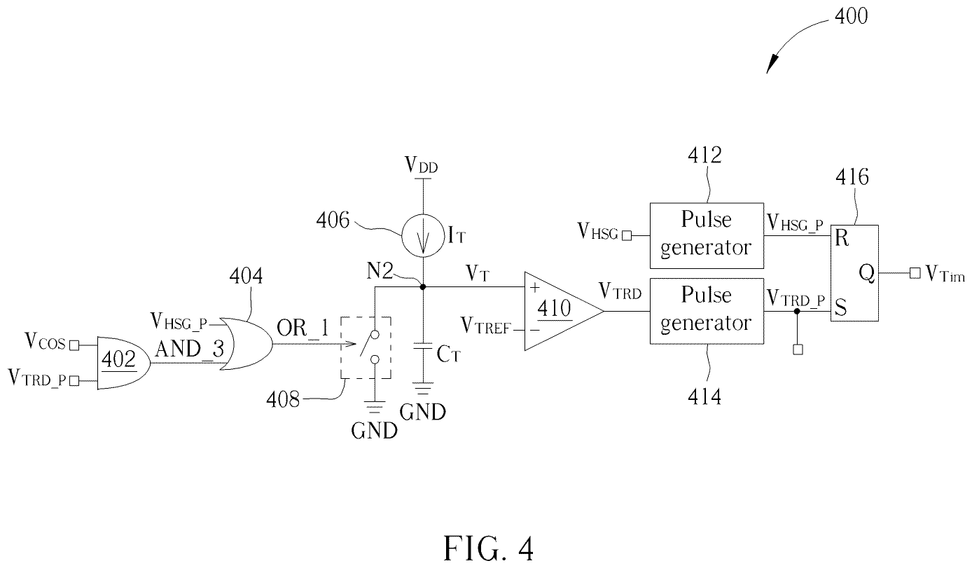

Specifically, refer to FIG. 4. FIG. 4 is a diagram illustrating a timer circuit 400 according to an embodiment of the present invention, wherein the timer circuit 308 shown in FIG. 3 may be implemented by the timer circuit 400. As shown in FIG. 4, the timer circuit 400 may include an AND circuit 402, an OR circuit 404, a current source 406, a switch 408, a comparator circuit 410, multiple pulse generator 412 and 414, and an SR latch circuit 416. The AND circuit 402 may be arranged to perform an AND operation upon the control signal V_{COS} and a pulse signal V_{TRD_P} in order to generate an AND gate output AND_3. The OR gate circuit 404 may be arranged to perform an OR operation upon the AND gate output AND_3 and the pulse signal V_{HSG_P} corresponding to the high-side switch driving signal V_{HSG} in order to generate an OR gate output OR_1, for triggering the switch 408. The current source 406 has a first terminal coupled to a supply voltage V_{DD} and a second terminal coupled to a node N2, and is arranged to provide a current I_{T}, wherein a voltage V_{T} is provided at the node N2. The switch 408 is coupled between the node N2 and the grounding voltage GND. The capacitor C_{T} is connected in parallel with the switch 408.

The comparator circuit 410 has a negative input terminal (labeled as “−” in FIG. 4) receiving a reference voltage V_{TREF}, a positive input terminal (labeled as “+” in FIG. 4) receiving the voltage V_{T}, and an output terminal outputting a comparison result V_{TRD}. The pulse generator 412 may be arranged to receive the high-side switch driving signal V_{HSG}, and generate the pulse signal V_{HSG_P} according to the high-side switch driving signal V_{HSG}. The pulse generator 414 may be arranged to receive the comparison result V_{TRD}, and generate the pulse signal V_{TRD_P} according to comparison result V_{TRD}. The SR latch circuit 416 has a reset input terminal (labeled as “R” in FIG. 4), a set input terminal (labeled as “S” in FIG. 4), and an output terminal (labeled as “Q” in FIG. 4), wherein the reset input terminal receives the pulse signal V_{HSG_P}, the set input terminal receives the pulse signal V_{TRD_P}, and a timer voltage V_{Tim} is generated at the output terminal. In this embodiment, the oscillation frequency F_{S} may be equal to the current I_{T} divided by a product of the capacitor C_{T} and the reference voltage V_{TREF}

$$( i . e . , {F}_{S} = \frac{{I}_{T}}{{C}_{T} * {V}_{TREF}} ) .$$

Refer back to FIG. 3. The AND circuit 310 may perform an AND operation upon an inverse signal of the determination signal V_{PKmin_Det}, the output level detection voltage V_{EAOK}, and the timer voltage V_{Tim}, in order to generate an AND gate output AND_4. The SR latch circuit 312 has a reset input terminal (labeled as “R” in FIG. 3), a set input terminal (labeled as “S” in FIG. 3), and an output terminal (labeled as “Q” in FIG. 3), wherein the reset input terminal receives the modulation signal V_{MOD}, the set input terminal receives the AND gate output AND_4, and an SR latch output SR_1 is generated at the output terminal. The logical circuit 314 may be arranged to receive the SR latch output SR_1, the output level detection voltage V_{EAOK}, the timer voltage V_{Tim}, the pulse signal V_{TRD_P}, the determination signal V_{PKmin_Det}, and the zero crossing detection voltage V_{ZCD}, and perform multiple third logical operations upon the above-mentioned received signals/voltages, in order to generate the high-side switch driving signal V_{HSG}, the low-side switch driving signal V_{LSG}, and the control signal V_{COS}. The buffer circuit 316 may be coupled between the logical circuit 314 and the high-side switch SW_{HS}, and may be arranged to buffer/drive and transmit the high-side switch driving signal V_{HSG} to the high-side switch SW_{HS}. Similarly, the buffer circuit 318 may be coupled between the logical circuit 314 and the low-side switch SW_{LS}, and may be arranged to buffer/drive and transmit the low-side switch driving signal Vis to the low-side switch SW_{LS}. Since the focus of the present invention is on the control circuit 110/200 that generates the modulation signal V_{MOD} and the determination signal V_{PKmin_Det} for dynamically setting the inductor peak current I_{PK}, and the operations of the logical circuit 314 are well known to those skilled in the art, further details for the logical circuit 314 are omitted here for brevity.

In summary, by the power stage control circuit 100 (more particularly, the control circuit 110/200 therein) of the present invention applied to a buck converter, when the inductor current I_{L} of the buck converter operates in the DCM, the inductor peak current I_{PK} is set to be greater than or equal to the reference current I_{PK_min} (i.e., I_{PK}≥I_{PK_min}) via logic control, which can make the inductor peak current I_{PK} not be limited (or dominated) by some parameters (e.g., the input voltage V_{IN}, the output voltage V_{OUT}, the minimum turn-on time of the high-side switch SW_{HS}, and the inductance value of the inductor L), and therefore can improve the design flexibility of the buck converter. In addition, when the inductor current I_{L} of the buck converter operates in the DCM and the inductor peak current I_{PK} is substantially equal to the reference current I_{PK_min}, a next charging cycle of the power stage 50 is performed only when the inductor current I_{L} of the inductor L is discharged to zero by controlling switching of the high-side switch SW_{HS} and the low-side switch SW_{LS} via the modulation signal V_{MOD} and the determination signal V_{PKmin_Det}, which can avoid occurrence of larger ripple of the output voltage V_{OUT}. That is, when the buck converter operates at a light load condition, the output voltage ripple can be effectively suppressed by the control circuit 110/200.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power stage control circuit applied to a voltage converter, wherein the voltage converter comprises a power stage, the power stage comprises a first switch and a second switch, the first switch and the second switch are connected in series between an input voltage and a first reference voltage, the input voltage is higher than the first reference voltage, and the power stage control circuit comprises:
a current sensing circuit, arranged to sense a current associated with the first switch, and convert the current into a sensing voltage;
a control circuit, arranged to perform multiple first logical operations according to the sensing voltage, a second switch driving signal, a zero crossing detection voltage, a compensation voltage, and a second reference voltage, in order to generate a modulation signal and a determination signal, for controlling turn-on and turn-off of the first switch and the second switch and dynamically setting an inductor peak current of an inductor, respectively, wherein the inductor has a first terminal coupled between the first switch and the second switch, and a second terminal coupled to an output pin providing an output voltage; and
a driving circuit, arranged to perform multiple second logical operations according to the modulation signal and the determination signal in order to generate a first switch driving signal and the second switch driving signal, for driving the first switch and the second switch, respectively.

2. The power stage control circuit of claim 1, further comprising:
an error amplifier, arranged to receive a feedback voltage and a third reference voltage in order to generate an error amplifier voltage; and
a subtraction circuit, arranged to subtract a slope compensation voltage from the error amplifier voltage in order to generate the compensation voltage.

3. The power stage control circuit of claim 1, wherein the inductor peak current of the inductor is dynamically set according to a reference current, the determination signal, and the compensation voltage; and the reference current is a product of a conductance of the current sensing circuit and the second reference voltage.

4. The power stage control circuit of claim 3, wherein when the first switch is turned on, in response to a voltage level of the determination signal being switched from a first level to a second level, the inductor peak current is set to be equal to the reference current; and the first level is lower than the second level.

5. The power stage control circuit of claim 3, wherein when the voltage level of the determination signal is a first level lower than a second level, and the compensation voltage is less than the second reference voltage at end of a turn-on time of the first switch, the inductor peak current is set to be less than the reference current.

6. The power stage control circuit of claim 3, wherein when the voltage level of the determination signal is a first level lower than a second level, and the compensation voltage is equal to the second reference voltage at end of a turn-on time of the first switch, the inductor peak current is set to be equal to the reference current.

7. The power stage control circuit of claim 3, wherein when the voltage level of the determination signal is a first level lower than a second level, and the compensation voltage is greater than the second reference voltage at end of a turn-on time of the first switch, the inductor peak current is set to be greater than the reference current.

8. The power stage control circuit of claim 1, wherein the control circuit comprises:
a discontinuous conduction mode (DCM) detection circuit, comprising:
a pulse generator, arranged to receive the second switch driving signal from the driving circuit, and generate a pulse signal according to the second switch driving signal;
a first AND gate circuit, arranged to perform an AND operation upon an inverse of the pulse signal and the zero crossing detection voltage in order to generate a first AND gate output; and
a set-reset (SR) latch circuit, having a reset input terminal, a set input terminal, and an output terminal, wherein the reset input terminal receives the pulse signal, the set input terminal receives the first AND gate output, and a DCM detection signal is generated at the output terminal for determining whether an inductor current of the voltage converter operates in a DCM.

9. The power stage control circuit of claim 8, wherein the control circuit further comprises:
a modulation circuit, comprising:
a first comparator circuit, having a negative input terminal coupled to the second reference voltage and a positive input terminal coupled to the sensing voltage;
a second comparator circuit, having a negative input terminal coupled to the compensation voltage and a positive input terminal coupled to the sensing voltage;
a NAND gate circuit, arranged to perform a NAND operation upon the DCM detection signal and an inverse of an output of the first comparator circuit, in order to generate a NAND gate output; and
a second AND gate circuit, arranged to perform an AND operation upon the NAND gate output and an output of the second comparator circuit, in order to generate the modulation signal.

10. The power stage control circuit of claim 9, wherein the control circuit further comprises:
a current setting circuit, comprising:
a third AND gate circuit, arranged to perform an AND operation upon the DCM detection signal and the output of the second comparator circuit, in order to generate a third AND gate output;
a delay circuit, arranged to perform a delay operation upon the output of the first comparator circuit, in order to generate a delayed result;
an inverter circuit, arranged to invert the zero crossing detection voltage in order to generate an inverted result; and
a D-type flip flop (DFF) circuit, having an input terminal, a clock terminal, a clear terminal, and an output terminal, wherein the input terminal receives the third AND gate output, the clock terminal receives the delayed result, the clear terminal receives the inverted result, and the determination signal is generated at the output terminal.

11. The power stage control circuit of claim 1, wherein a reference current is a product of a conductance of the current sensing circuit and the second reference voltage; and when an inductor current of the voltage converter operates in a discontinuous conduction mode (DCM), the inductor peak current of the inductor is set to be greater than or equal to the reference current.

12. The power stage control circuit of claim 1, wherein a reference current is a product of a conductance of the current sensing circuit and the second reference voltage; and when an inductor current of the voltage converter operates in a discontinuous conduction mode (DCM), and the inductor peak current of the inductor is equal to the reference current, a next charging cycle of the power stage is performed only after an inductor current of the inductor is discharged to zero.

13. The power stage control circuit of claim 1, wherein the voltage converter is a buck converter.
